(19) United States
(12) Patent Application Publication
(10) Pub. No.: US 2011/0184552 A1
(43) Pub. Date: Jul. 28, 2011

(54) ERROR LOGGING IN A METHOD FOR PREPARING ITEMS TO BE MAILED

(75) Inventor: René VAN DEN BERG, Groningen (NL)

(73) Assignee: NEOPOST TECHNOLOGIES, Bagneux (FR)

(21) Appl. No.: 13/012,382

(22) Filed: Jan. 24, 2011

(30) Foreign Application Priority Data
Jan. 22, 2010 (EP) 10075035.5

(51) Int. Cl. G06F 7/00

(52) U.S. Cl. 700/220

(57) ABSTRACT

A method for preparing a batch of mail pieces includes transporting postal items from at least one feeding station to an inserting station and inserting the postal items into envelopes. If a control logic detects a signal representing a disturbance of the transportation of at least one of the postal items, in response to that detection, the control logic automatically generates an error report representing information regarding the detected disturbance of postal items. The error report includes batch preparation data representing at least one predetermined processing feature applicable to the preparation of the batch of mail pieces. The error report is stored to be made available for service and support.

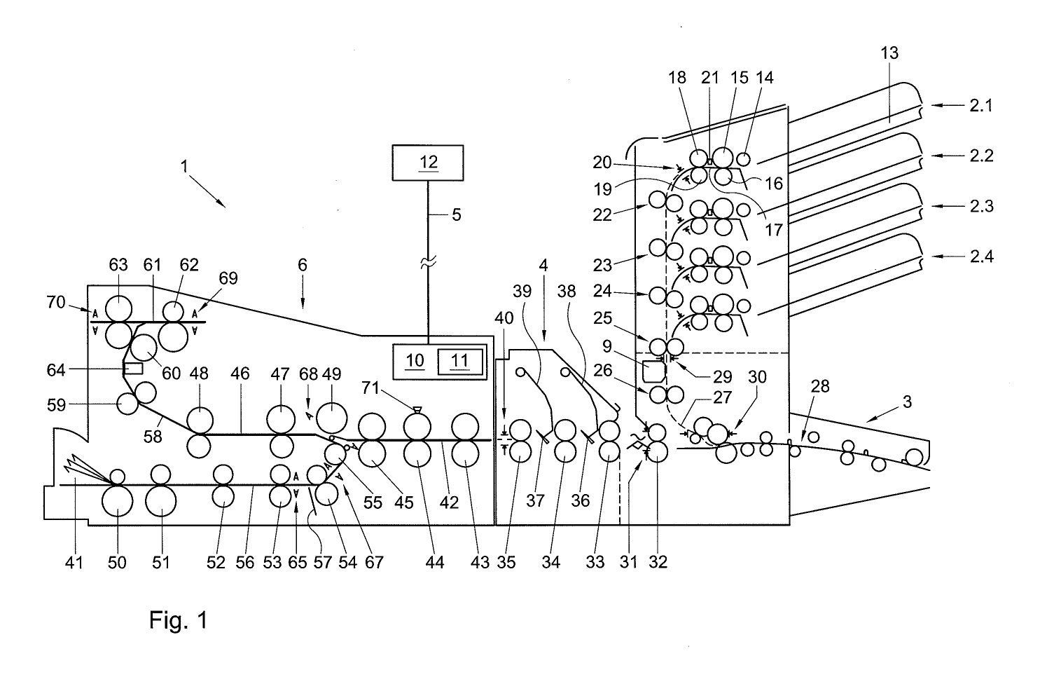

### FIELD AND BACKGROUND OF THE INVENTION

The invention relates to a method for preparing mail pieces. When preparing mail pieces in a mail preparation system such as an inserting system, the processing of postal items into mail pieces may be interrupted by a malfunction, for instance misalignment or unwarranted buckling, folding or tearing of a sheet. In the event of such a malfunction, usually an error log is generated containing error data representing the error in order to take occurred errors into account during repair and/or maintenance of the apparatus. Each error constitutes an indication of what went wrong and which part of the apparatus may need to be examined, repaired or replaced.

For the purpose of service support it is favorable to be able to diagnose the cause of errors from a remote location. By making the error data available at the remote location, it is made possible to diagnose the cause of errors systems and to decide upon advisable steps to remove the cause of the errors and on aspects of maintenance or to assist an operator in solving the problems from the remote location.

However, the success rate and the range of problems that can be resolved on the basis of remotely obtained error data leaves room for improvement.

### SUMMARY OF THE INVENTION

It is an object of the present invention to more effectively provide customer support and improve servicing of an inserter system to improve the reliability of a method for preparing mail pieces using an inserter system on the basis of remotely available error data made available at a remote location.

According to the invention, this object is achieved by providing a method for preparing a batch of mail pieces including: transporting postal items from at least one feeding station to an inserting station; and inserting the postal items into envelopes by the inserting station. If a control logic detects a signal representing a disturbance of the transportation of at least one of the postal items, in response to said detection, the control logic automatically generates an error report representing information regarding the detected disturbance of postal items, the error report comprising batch preparation data representing at least one predetermined processing feature applicable to the preparation of the batch of mail pieces; and the error report is stored.

Because the error report comprises batch preparation data representing at least one predetermined processing feature applicable to the preparation of the batch of mail pieces, information regarding applicable batch preparation data that may have affected the occurrence of the disturbance is made possible. This allows better diagnosis of the likely cause of the error from a remote location and without reliance on personal contact with an operator at the site of the mail preparation system.

According to a particular embodiment of the invention, if the control logic detects a signal representing a disturbance of the transportation of at least one of the postal items, in response to said detection, image data defining an image of at least a portion of a postal item of the type of postal items of which the transport is disturbed are obtained or a reference to said image data is obtained and the error report includes these image data.

Other particular embodiments of the invention are set forth in the dependent claims.

Further objects, features, effects and details of the invention are described below.

### BRIEF DESCRIPTION OF THE DRAWING

The drawing represents a schematic side view of an example of a system for preparing postal items.

### DETAILED DESCRIPTION

The apparatus 1 shown in the drawing has processing stations 2.1, 2.2, 2.3, 2.4, 3, 4, 6 arranged in series in a processing order. In the processing order, the stations of the system 1 according to the present example are feeding stations 2.1, 2.2, 2.3, 2.4, each for separating and feeding separated sheets from a stack, a gathering station 3 for gathering sheets fed from the feeding stations 2.1, 2.2, 2.3, 2.4, a folding station 4, and an inserting station 6. The system further comprises a scanner 9 downstream of the feeding station 2 and upstream of the gathering station 3 for scanning postal items passing along the scanner 9. A control logic 10 in the form of a programmable circuitry is connected to the stations for controlling operation of the system. The control logic 10 has a memory 11 for storing data. The control logic 10 is connected to a computer system 12 at a location remote from the apparatus 1 via a network connection 5. The network connection may include for instance a local area network, an internet connection, a public telephone network and/or a connection via a wireless network, such as a mobile telephone network.

The feeding stations 2.1-2.4 each have a feeding tray 13 for supporting a stack of sheets from which the sheets are to be separated and fed one by one. The separating system of each of the feeding stations 2.1-2.4 includes a supply roller 14, separating rollers 15, 16 defining a separating nip in-between and feeding rollers 18, 19 defining a transport nip in-between. In operation, topmost sheets are supplied to the separating nip by the supply roller contacting an uppermost sheet of the stack. In the separating nip, a topmost sheet is urged in feeding direction towards the feeding nip by the topmost separating roller 15 and any sheets entrained with the topmost sheet are withheld by the lower separating roller 16 urging these sheets in a direction opposite the feeding direction. For detecting the arrival of a separated sheet in the feeding position, each feeding station has a presence sensor 20. In the present example, the presence sensors are each provided in the form of a light source and a photocell on opposite sides of the feeding path that extends through from the feeding tray 13 via the separating and feeding nips. A sheet guide 17 extends along the feeding path. Furthermore, each feeding station 2.1-2.4 includes a thickness measuring unit 27 for detecting the feeding of double sheets, which may result from incomplete separation of successive sheets.

Successive pairs of transport rollers 22, 23, 24, 25, 26 define a sheet transport path 27 from the topmost feeding station 2.1, into which sheet transport path 27 sheet feeding paths from the other feeding stations 2.2, 2.3 and 2.4 merge and along which the scanning station 9 is located. The scanner 9 is arranged for scanning postal items passing along the sheet feeding path 27 and providing a signal representing a scanned image of the postal items or a portion of the postal item to the control logic 10.

The sheet feeding path 27 leads to a gathering position 28 in the gathering station 3. For monitoring paper transport along the sheet transport path 27, a presence sensor 29 is provided along the sheet transport path 27. In the present example, the presence sensor 29 along the sheet transport path 27 is also provided in the form of a light source and a photocell.

Downstream of the presence sensor 29 along the sheet transport path 27, a further presence sensor 30 is provided along the sheet transport path 27 for monitoring the arrival of sheets in the gathering position 28. After sheets arrived from one or more of the feeding stations 2.1-2.4 have been gathered at the gathering position or, if a set is to consist of a single sheet only, after that sheet has arrived at the gathering position 28, the sheet or sheets of the set are transported to the folding station 4. Further details regarding the gathering of sheets in a station according to the present example are disclosed in European patent 0 556 922.

The gathering station 3 has a further presence sensor 31 in the form of a light source and a photocell along a transport path downstream of a transport roller pair 32. When the sheet or sheets of a set are outputted by the gathering station 3 towards the folding station 4, the sheet or sheets are detected by presence sensor 31.

The folding station 4 has a transport roller pair 33 at its entry and first and second folding facilities, each constituted by a deflector 36 or 37, a folding knife 38 or 39 and a folding roller pair 34 or 35. Further details regarding the folding of sheets in a folding station according to the present example are disclosed in European patent 0 312 177. At the exit of the folding station 4, downstream of the last folding roller pair 35, a further presence sensor 40 in the form of a light source and a photocell along a transport path towards the inserting station 6 is provided.

The inserting station 6 has an envelope hopper 41 for holding a stock of envelopes into which postal items arriving via a postal item supply path 42 passing between transport roller pairs 43, 44, 45 are to be inserted. The supply path 42 leads to an inserting position 46 in the form of a plane extending through nips between the rollers of roller pairs 47, 48. Immediately upstream of the inserting position an inserting roller pair 49 is located defining a nip in which postal items are finally urged into an envelope in the inserting position when being inserted. Envelope transport roller pairs 50-55 define an envelope transport path 56 extending through nips between the rollers of the respective pairs 50-55. The envelope transport path 56 extends from the envelope hopper 41 to the inserting position 46. An envelope flap opener 57 is arranged along the envelope transport path 56.

From the inserting position 46, a mail piece transport path 58 extends through nips between mail piece transport roller pairs 59, 60 to a mail piece end position 61 extending through a nip between a mail piece reversal roller pair 62. An envelope flap moistener 64 is arranged along the mail piece transport path 58 for moistening flaps of successive envelopes in mail piece transport path 58 passing along the moistener 64. After a mail piece has reached the mail piece end position 61, it is stopped and transported away in a direction opposite to the direction of arrival through a folding nip between a folding roller 63 and one of the rollers of the most downstream mail piece transport roller pair 60, which roller is also provided in the form of a folding roller (i.e. having an axial size spanning substantially the entire width of the transport path). As the mail piece is passed through the nip between the folding rollers, the flap of the envelope is closed and pressed against the envelope body so that the flap is adhesively secured against the envelope body. Further details regarding the closing of envelopes in such an inserter are disclosed in European patent 0 825 037.

For monitoring and controlling the operation of the inserter 6, the inserter is provided with several presence sensors, each in the form of a light source and a photocell. Along the envelope transport path 56, first and second envelope presence sensors 65 and 67 are arranged for detecting the passage of an envelope. In operation, the first envelope sensor 65 detects the leading and trailing edges of the envelope. As the envelope passes the scraper 57, the envelope flap is opened and subsequently trails the envelope body along the envelope transport path 56. The flap is thus the trailing part of the envelope as it passes the second envelope presence sensor 67.

Measurement of pulses associated to rotation of one of the envelope transport rollers during the presence of the envelope at the first envelope presence sensor provides information on (a) the length of the not yet opened envelope; (b) the opened envelope; and (c) the moment at which the envelope transport is to be stopped so that the envelope stops in the inserting position with the envelope flap held in a nip between the most downstream roller pair 55 along the envelope transport path 56.

Once the envelope is in the inserting position 46, envelope opening fingers (not shown) are inserted into the envelope to hold the envelope throat open for receiving the associated set of folded postal items therein.

The rollers 43-45 of the supply path 42 are then driven to supply the postal item or set of postal items to be inserted. One of the rollers of the second transport roller pair 44 along the supply path 42 is coupled to a displacement sensor 71 which allow measuring the thickness of a postal item or set of postal items. This allows to check whether the postal item or set of postal items has a thickness pattern corresponding to its intended composition and folding configuration. A further presence sensor 68 just upstream of the inserting position 46 allows verifying the presence of the postal item or set of postal items immediately prior to insertion into the envelope.

The insertion of the postal item or set of postal items is considered finished if and when the presence sensor 68 detects the trailing edge of the postal item or set of postal items. In response, a clutch (not shown) coupled to roller pair 55 is operated to disengage, so the roller pair 55 releases the flap. Roller pairs 47, 48 through the nips of which the inserting position 46 extends are pressed together from a mutually spaced position for avoiding interference with the insertion of the postal item or items, so that the filled envelope is engaged and can be transported away into the mail piece transport path 58.

While a next envelope is transported to the inserting position, the filled envelope passes the flap moistener 64 until it reaches a position between the rollers of the reversal roller pair 62 which are held in a position spaced apart. When a reversal sensor 69 detects the presence of an envelope, a solenoid (not shown) is activated so that the rollers of the reversal roller pair 62 engage the envelope and reverse the transport direction of the envelope, so that the initially trailing edge of the envelope body becomes the leading edge of the envelope body and is transported through the nip between folding roller 63 and the folding roller of the roller pair 60. After passing the folding rollers, the envelope is discharged along a presence sensor 70.

Before the start of a job of processing postal items into a batch of mail pieces, one or more of the feeding station 2.1-2.4 are loaded with postal items to be mailed. Furthermore, an operator inputs various batch preparation settings (also commonly referred to as “job settings”) applicable to the preparation of the batch of mail pieces that is to follow, such as the number of inserts per postal items or rules determining whether or not to add inserts and the folding configuration. In general, batch preparation settings relate to settings determining the actions to be performed by the different stations of the apparatus until the completion of the preparation of that batch of mail pieces. Instead of by the operator, one or more of the batch preparation setting may de determined by the control logic from information regarding the loaded postal items and processing rules.

For detecting disturbances of the operation, the control logic is programmed to generate a warning signal and/or to stop the apparatus 1 in response to signals from the presence sensors that are not in accordance with predetermined ranges of expected signals. For instance, the time after initiation of transporting a postal item until presence at a presence sensor may be too long, a postal item may be present at a presence sensor too long or too short or presence of an item may be detected when no item should be present at the given sensor. Moreover, the thickness sensors 21, 71 can indicate whether a measured thickness is in accordance with an expected thickness. This may be achieved simply by checking whether successive items or sets that should be identical have substantially (i.e. within a measurement error and thickness tolerance range that allows to distinguish an item or a set from an item of a different type or from a set of a different composition) the same measured thickness.

If a potential error is detected by the control logic 10 comparing signals from the sensors with expected signals that should be detected during normal operation, the control logic 10 generates an error report including an indication of the location where the error was detected and of detected disturbance, e.g. a code representing no timely appearance of a postal item in the gathering position 28, along with the date and time of the detection of the disturbance and the number of postal items transported. This generated error report is stored by the control logic 10 and transferred to or made available for reading from a remote location 12 via the network connection 5.

Batch preparation data applicable to the preparation of the batch of mail pieces being prepared at the moment the error was detected are included in the error report. The batch preparation data represent at least one predetermined processing feature that is applicable to the preparation of the batch of mail pieces being prepared at the moment the error was detected. The batch preparation data may for instance include batch preparation settings, information regarding the type of postal items, envelopes being processed and/or information regarding processing parameters, such as temperature, humidity or resistance encountered by one or more motors of the apparatus (for instance represented by the electric power consumption of the motor or motors). Including batch preparation data in the error report facilitates remote diagnosis of the likely cause of the disturbance without obtaining information from an operator of the system and, subsequently improved remote assistance to the operator or service personnel. Also, relations between types of disturbances and batch preparation parameters can be obtained by statistical analysis of error data obtained from a plurality of installed apparatuses.

In addition to the batch preparation data, also mail piece preparation data applicable to the individual postal item or mail piece to which the error signal appears to relate can be included in the error report. This allows to specifically obtain information on the processing operation and/or the type of postal item that (presumably) was being processed at the moment the error occurred.

The batch preparation data to be included in the error data in the event of an error signal may also include mail piece composition data representing information regarding at least one property of the type of postal item or of the set of items to which the error signal relates. This allows to gather information regarding the likelihood of errors occurring during the processing of particular types of postal items. On the basis of such information, for instance adjustments to the apparatus can be made or advice can be provided regarding properties of postal items to be processed. For example, if the batch preparation of the folding station 4 is programmed to fold to a Z-fold configuration, a cardboard insert may hamper such a folding operation, resulting in a disturbance of the transport of the postal items out of the folding station 4.

The batch preparation data may include, for each postal item, or at least each different type of postal items, a reference image representing the type of postal item. Reference images of a postal item of each type can for instance be captured by the scanner 9 when the items pass by the scanner 9. An image captured from the first postal item of a given type may for instance be stored as a reference image representative of that postal item type. In the event of a disturbance, the reference image or a reference to a file containing data representing that image is then included in the error report. When a number of different types of postal items is processed, a corresponding number of reference images may be stored in the memory 11 of the control logic 10. The availability of one or more images of the type or types of the postal item or items involved in a detected disturbance in the operation of the inserting system allows to very reliably obtain information on the type or types of postal items involved in the disturbance, without having to rely to predetermined lists of postal item type codes or the like, which are cumbersome to maintain and unreliable if not properly maintained and updated. Also, operators and service technicians can easily compare the images in the error reports with specimens of the postal items available on-site, so that the relevant materials of which further analysis may be advisable can be gathered easily and reliably.

The postal items of a particular type, to which a particular reference image is associated, may be mutually different to some extent, for instance with respect to personal data on the postal items.

It is also possible to associate further reference images to a type of postal items, each reference image associated to a postal item type showing at least a portion of a postal item of that type in a different orientation. Two reference images may for instance show a first and a second, opposite face of a document or the same face of a document with the top end up and with the bottom end up. Thus, if a document can be displayed in both landscape and portrait orientations (or if it is square), up to eight reference images may show a postal item of the same type, or portions thereof, in up to eight different orientations. Such additional reference images for postal items of the same type may be helpful to detect whether a relationship exists between the occurrence of an error and the orientation in which the postal item has been fed. Postal items for which such a relationship is more likely to occur than others are for instance reply envelopes and items with a particular type of printing or coating on one side only. It is noted that distinguishing images of postal items having the same side up but oriented differently may also be achieved by processing image data of the captured image or of the reference image.

If the image associated to the type of postal item is included in the error data by including a reference to a file containing the error data in the error data, the amount of data to be included in the error data can be reduced, which is particularly advantageous for quick storage of the error data by a control logic having a fairly small data processing capacity.

Instead of during the preparation of mail pieces, it is also possible to capture the images prior to preparation of the postal items for instance by printing-to-file data for printing the postal item. For example, when the postal item was printed by a printer provided in the apparatus, the print file is already available. This file is then stored either in the memory 11 of the control logic 10 or in a memory that is not part of the inserting apparatus.

The image, whether captured from a postal item of the respective type or by print-to-file, can contain information that is confidential, such as personal information that should be kept confidential to maintain the privacy of the persons involved, or other confidential information, such as financial or business data. To prevent that such data become available to persons that should not obtain access to the data, data representing a provisionally obtained image can be processed into data representing a final, processed image that does not contain the confidential information, but is still clear enough to recognize the type of postal item. This can for instance be achieved by blurring of the provisional image. This processing of the provisional image may for instance be performed by the control logic 10. It is also possible to provide that the lens of the scanner is adapted for prevention of capturing images showing readable characters, for instance by arranging a patterned of diffusing filter in front of or behind the lens or by ensuring that the lens is slightly out of focus. In another embodiment this is achieved by reducing the resolution of the image. In yet another embodiment making the confidential information unavailable is achieved by overlaying of subsequent images scanned producing a new image of two or more transparent images.

It is also possible to provide that each paper tray of a feeding station is provided with a scanner, or other image recorder such as a camera, for capturing an image. When different types of postal items are loaded in different paper trays and postal items of the same type are loaded in the same paper tray, images provided by each scanner represent a different type of postal item. This scanning of images in the feeding station to obtain and store job composition data is preferably performed prior to the actual start of the processing of the postal items into mail pieces.

While the invention has been illustrated and described in detail in the drawing and foregoing description, such illustration and description are to be considered illustrative or exemplary and not restrictive; the invention is not limited to the disclosed embodiments.

Scanners or other image recorders, such as cameras may for instance be provided at various locations in the processing stations. In the event of a detected disturbance of transport of postal items, it is determined which image data to include in the error report on the basis of the location data representing the location of the disturbance. The location data may be included in the error report. An image or images obtained by a scanner associated to (for instance at or immediately upstream of) the location indicated by the location data may for instance be included in the error report. This provides the advantage that the right image is stored even if wrong postal items have been reloaded during preparation of a batch of mail pieces or if an error in the transportation of the postal items has resulted in another postal item than the anticipated postal item was present at or near the location where the error was detected.

It is also possible to arrange the control logic such that in response to the signal representing a disturbance of the transportation a captured image of at least one of the postal items involved or at least detected to be involved in the disturbance is compared with the reference image for the postal item type of that postal item.

If at least a predetermined extent of similarity between the reference image and the captured image is found, the control logic includes image data defining the reference image or a reference thereto in the error report. Thus, a very clear image representative for a type of postal items can be provided without showing any personal details that may be visible in the captured image or processing of the captured image to remove such details.

If less than a predetermined extent of similarity between the reference image and the captured image is found, the control logic includes image data defining the captured image or a reference thereto in the error report. Thus allows to obtain an indication which type of postal items were loaded instead of the type of postal items shown in the stored reference image. Loading the wrong type of postal items entails a relatively high risk of disturbance of the transport, in particular if the apparatus is not properly adjusted for processing the loaded wrong type of postal items. In such cases, it is also advantageous to show the error report to the operator with the indication that the type of postal items loaded does not match the type of postal items associated to the stored reference image. Preferably, the reference image is then also shown, to indicate to the operator which type of postal items should have been loaded. The operator can then unload the loaded postal items of the wrong type and load the postal items of the indicated type or, if the error is in the batch preparation data, change the batch preparation data to store the right reference image or add a reference image for a different postal item type or a differently oriented postal item of the same postal item type as an also allowed alternative.

The captured image may be one of series of images that are captured for a series of mail pieces. The image data of the captured images may for instance each be discarded or overwritten after completion of a mail piece including the postal item from which the image was captured has been detected. The images may also be stored and, if desired, be collectively erased after completion of the batch of mail pieces.

For example, one or more of the feeding stations or the single feeding station may be constituted by a printer for in-line printing of postal items and individually feeding each of the printed postal items from the printer.

Other variations to the disclosed embodiments can be understood and effected by those skilled in the art in practicing the claimed invention, from a study of the drawings, the disclosure, and the appended claims.

1. A method for preparing a batch of mail pieces comprising:
transporting postal items from at least one feeding station to an inserting station;
the inserting station inserting the postal items into envelopes; and
if a control logic detects a signal representing a disturbance of the transportation of at least one of the postal items, in response to said detection:
the control logic automatically generating an error report representing information regarding the detected disturbance of postal items, the error report comprising batch preparation data representing at least one predetermined processing feature applicable to the preparation of the batch of mail pieces; and
storing the error report.

2. A method according to claim 1, further comprising, in response to said detection: obtaining location data representing information regarding at least a location where the disturbance of transport was detected and including the location data in the error report.

3. A method according to claim 1, further comprising: obtaining postal item type data representing information regarding at least one property of the type of postal items of which the transport is disturbed and including the postal item type data in the batch preparation data in the error report.

4. A method according to claim 1, wherein the postal item type data comprise information regarding at least one material property of the type of postal items.

5. A method for preparing a batch of mail pieces comprising:
transporting postal items from at least one feeding station to an inserting station; and
the inserting station inserting the postal items into envelopes;
further comprising, if a control logic detects a signal representing a disturbance of the transportation of at least one of the postal items, in response to said detection:
obtaining image data defining an image of at least a portion of a postal item of the type of postal items of which the transport is disturbed or a reference to said image data;
the control logic automatically generating an error report representing information regarding the detected disturbance of postal items, the error report comprising said image data; and
storing the error report.

6. A method according to claim 5, wherein said image data define a reference image that is the same for mutually different items of one postal item type.

7. A method according to claim 5, wherein said image data define a reference image for postal items of one postal item, type further comprising, in response to the signal representing a disturbance of the transportation of at least one of the postal items:
comparing a captured image of that postal item with the reference image for the postal item type of that postal item;
if at least a predetermined extent of similarity between the reference image and the captured image is found, including image data defining the reference image or a reference thereto in the error report; and
if less than a predetermined extent of similarity between the reference image and the captured image is found, including image data defining the captured image or a reference thereto in the error report.

8. A method according to claim 5, wherein said image data representing an image representing the type of postal items are captured from an item of that postal item type in or downstream of the feeding station.

9. A method according to claim 5, wherein said image data are established by printing-to-file in accordance with print data for printing one item of that type of postal items.

10. A method according to claim 5, wherein said image data are established during preparation of the postal items of that type.

11. A method according to claim 5, wherein said image data define an image from which confidential data on the postal item cannot be derived.

12. A method according to claim 11, wherein said image is a final image obtained by blurring at least a portion of a provisional image.

13. A method according to claim 11, wherein said image is a final image obtained by reducing the resolution of at least a portion of a provisional image.

14. A method according to claim 5, wherein the postal item type data comprise information regarding at least one material property of the type of postal items.
